(19) United States
(12) Patent Application Publication
(10) Pub. No.: US 2015/0362785 A1
(43) Pub. Date: Dec. 17, 2015

(54) DISPLAY DEVICE

(71) Applicant: Electronics and Telecommunications Research Institute, Daejeon (KR)

(72) Inventors: Gi Heon KIM, Daejeon (KR); Won Jae LEE, Daejeon (KR)

(73) Assignee: Electronics and Telecommunications Research Institute, Daejeon (KR)

(21) Appl. No.: 14/606,059

(22) Filed: Jan. 27, 2015

(30) Foreign Application Priority Data
Jun. 12, 2014 (KR) 10-2014-0071374

(51) Int. Cl. G02F 1/1347; G02F 1/1333

(52) U.S. Cl. CPC G02F 1/13475; G02F 1/133305

(57) ABSTRACT

Provided is a display device. The display device includes a first electrode, a second electrode facing and separated from the first electrode, a liquid crystal layer filling up a space between the first and second electrodes, an organic layer disposed between the second electrode and the liquid crystal layer, and a dye disposed in the liquid crystal layer and fixed to the organic layer.

### CROSS-REFERENCE TO RELATED APPLICATIONS

This U.S. non-provisional patent application claims priority under 35 U.S.C. §119 of Korean Patent Application No. 10-2014-0071374, filed on Jun. 12, 2014, the entire contents of which are hereby incorporated by reference.

### BACKGROUND

The present disclosure herein relates to a display device, and more particularly, to a liquid crystal display device.

According to the development of modern society into the high technology age, the significance of display industry is increasing. Recently, as a display device becomes large-sized and has a slim structure, a flat panel display (FPD) such as a liquid crystal display (LCD), a plasma display panel (PDP), an organic light-emitting display (OLED), etc. is in use. In the LCD, white light from a backlight is modified during passing through two polarization plates and a liquid crystal layer, and the modified light passes a color filter and realizes color.

The LCD is driven by a low voltage and has small power consumption, and is widely used in a portable mobile device, a laptop computer, a computer monitor, TV, etc. However, the light from the backlight is partially used in the LCD due to the use of a polarization plate and a color filter. Thus, light loss is large, and a large portion of the power consumption is consumed for driving the backlight.

### SUMMARY

The present disclosure provides a display device realizing color images with high transmittance by using low production cost per unit.

The tasks to be solved by the present inventive concept is not limited to the above-described tasks, however other tasks not mentioned will be precisely understood from the following description by a person skilled in the art.

Embodiments of the inventive concept provide a display device. The display device includes a first electrode, a second electrode facing and separated from the first electrode, a liquid crystal layer filling up a space between the first and second electrodes, an organic layer disposed between the second electrode and the liquid crystal layer, and a dye disposed in the liquid crystal layer and fixed to the organic layer.

In some embodiments, the organic layer may include at least one group selected from the group consisting of HS—, CH₂═CH—, epoxy- and Cl—, and the at least one group may be a reactive group for fixing the dye.

In other embodiments, the dye may include at least one group selected from the group consisting of —H, CH₂═CH—, H₂N—, epoxy-, HO—, CH₃, C₂H₅, and an alkyl chain having at least C₃, and the at least one group may react with a reactive group of the organic layer.

In still other embodiments, the dye may include an aromatic ring or a condensed ring.

In even other embodiments, the organic layer may include a compound having the following Formula:

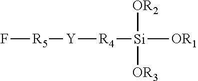

where R₁, R₂, and R₃ may include H, CH₃, C₂H₅, and C₃H₇, R₄ may include CH₂, C₂H₄, C₃H₆, and C₄H₈, Y may include O, CONH, COO, and OCO, R₅ may have an aliphatic compound structure of C₂ to C₇, F may include at least one selected from the group consisting of HS—, CH₂═CH—, epoxy-, and Cl—.

In yet other embodiments, the dye may include a yellow dye, a cyan dye, and a magenta dye.

In further embodiments, the dye may be aligned according to the alignment of liquid crystal molecules in the liquid crystal layer.

In still further embodiments, the liquid crystal molecules in the liquid crystal layer may be aligned in a vertical direction with respect to a surface of the first electrode, and the dye fixed to the organic layer may be aligned in a substantially the same direction as an alignment direction of the liquid crystal molecules to realize images, with voltage difference between the first and second electrodes.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is an exploded perspective view for explaining a display device according to an embodiment of the inventive concept;

FIG. 2 is a cross-sectional view taken along line I-I′ in the display device in FIG. 1;

FIGS. 3A and 3B are cross-sectional views for explaining the driving method of the display device in FIG. 2; and

FIG. 4 is an exploded perspective view for explaining the display device according to another embodiment of the inventive concept.

### DETAILED DESCRIPTION OF THE EMBODIMENTS

The above objects, other objects, features and advantages of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

It will also be understood that when an element is referred to as being ‘on’ another element, it can be directly on the other element, or intervening elements may also be present. In the drawings, the thickness of elements is exaggerated for effective explanation of illustration.

In addition, example embodiments are described herein with reference to cross-sectional views and/or plan views that are schematic illustrations of idealized example embodiments. In the drawings, the sizes and relative sizes of layers and regions may be exaggerated for effective explanation of technical contents. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, a region illustrated as a rectangle will, typically, have rounded or curved features. Thus, the regions illustrated in the figures are schematic in nature and their shapes are not intended to illustrate the actual shape of a region of a device and are not intended to limit the scope of the present inventive concept. It will be understood that, although the terms first, second, etc. may be used herein to describe various elements, these elements should not be limited by these terms. These terms are only used to distinguish one element from another element. Example embodiments embodied and described herein may include complementary example embodiments thereof.

The terminology used herein is for the purpose of describing particular example embodiments only and is not intended to limit the present inventive concept. As used herein, the singular forms are intended to include the plural forms as well, unless the context clearly indicates otherwise. It will be further understood that the terms “comprises” and/or “comprising,” when used in this specification, specify the presence of stated elements, but do not preclude the presence or addition of one or more other elements.

Hereinafter, exemplary embodiments of the inventive concept will be described in detail with reference to the accompanying drawings.

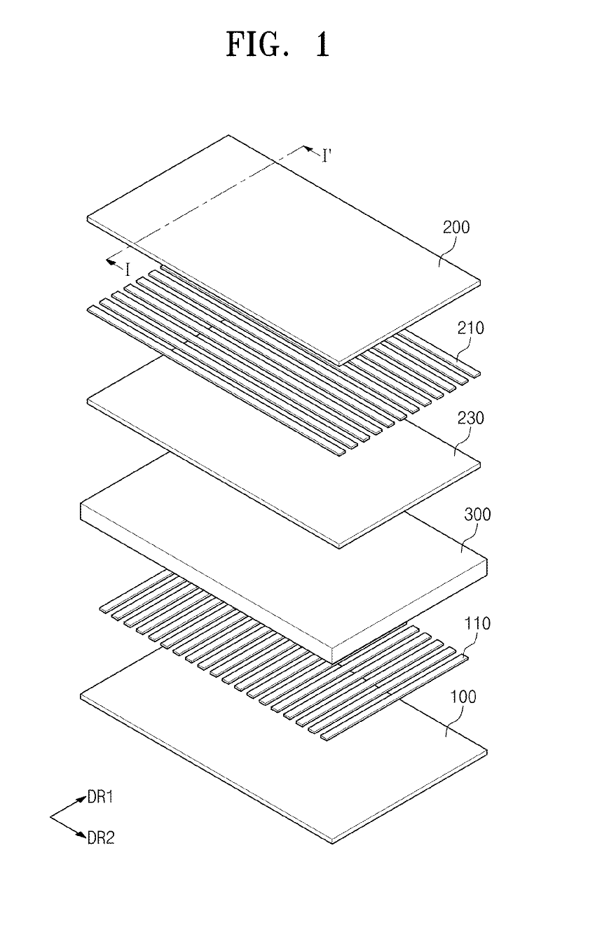

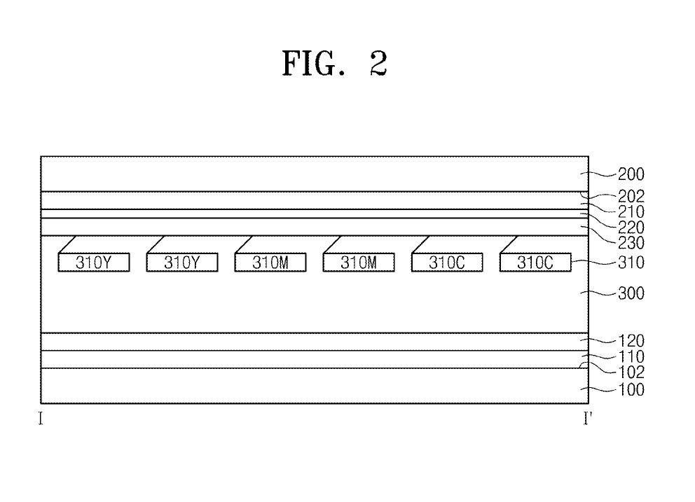

FIG. 1 is an exploded perspective view for explaining a display device according to an embodiment of the inventive concept, and FIG. 2 is a cross-sectional view taken along line I-I′ in the display device in FIG. 1.

Referring to FIGS. 1 and 2, a display device may include a first substrate 100, a second substrate 200, and a liquid crystal layer 300 including a dye 310 filling up the space between the first and second substrates 100 and 200. The display device according to an embodiment of the inventive concept will be explained referring to a display device having a passive matrix structure.

The first substrate 100 is a transparent substrate and may include glass or plastic. The first substrate 100 may include one side 102 facing the second substrate 200.

On the one side 102 of the first substrate 100, a first electrode 110 and a first insulation layer 120 may be sequentially disposed. The first electrode 110 is a transparent electrode and may include indium tin oxide (ITO), indium zinc oxide (IZO), silver nanowire, carbon tube, graphene, poly(3,4-ethylenedioxythiophene):poly(styrene-sulfonate) (PEDOT:PSS), polyaniline, polythiophene, or a mixture thereof. The first electrode 110 may have a stripe shape extended in a first direction DR1.

The first insulation layer 120 is a transparent insulation layer and may include an organic material including polyimide, polyacrylate, epoxy, polyvinyl alcohol, parylene, polystyrene, polyacetate, polyvinyl pyrrolidone, a fluorine-based polymer, polyvinyl chloride, or a compound including at least one repeating unit thereof. In addition, the first insulation layer 120 may include an inorganic material including silicon oxide (SiO), silicon nitride (SiN), silicon oxynitride (SiON), silicon carbide (SiC), silicon oxycarbide (SiOC), or a material including at least one thereof.

The second substrate 200 is a transparent substrate and may include glass or plastic. The second substrate 200 may include one side 202 facing the first substrate 100.

On the one side 202 of the second substrate 200, a second electrode 210 and an organic layer 230 may be sequentially disposed. The second electrode 210 may include ITO, IZO, silver nanowire, carbon tube, graphene, PEDOT:PSS, polyaniline, polythiophene, or a mixture thereof. The second electrode 210 may have a stripe shape extended in a second direction DR2 which is perpendicular to the first direction DR1.

Selectively, a second insulation layer 220 may be further provided between the second electrode 210 and the organic layer 230. The second insulation layer 220 may be a transparent insulation layer and may include an organic material including polyimide, polyacrylate, epoxy, polyvinyl alcohol, parylene, polystyrene, polyacetate, polyvinyl pyrrolidone, a fluorine-based polymer, polyvinyl chloride, or a compound including at least one repeating unit thereof. In addition, the second insulation layer 220 may include an inorganic material including SiO, SiN, SiON, SiC, SiOC, or a material including at least one thereof.

The organic layer 230 may include the structure of the following Formula 1.

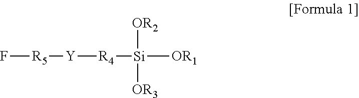

where R₁, R₂, and R₃ include H, CH₃, C₂H₅, and C₃H₇, each of R₁, R₂, and R₃ may be the same or different. R₄ includes CH₂, C₂H₄, C₃H₆, and C₄H₈, and R₄ may be omitted according to the purpose of use. Y includes O, CONH, COO, and OCO, and may be omitted according to the purpose of use. R₅ may have an aliphatic compound structure (may have a branched structure as occasion demands) of C₂ to C₇. F is a reactive group for fixing the dye 310 and may include at least one selected from the group consisting of HS—, CH₂═CH—, epoxy-, and Cl—.

A process of forming the organic layer 230 on the second electrode 210 will be explained in brief. Terminal alkoxy groups in the organic layer 230 having the structure of the above Formula 1 are hydrolyzed using water and an acid catalyst to be substituted with reactive silano groups. Then, the product thus produced may be coated on the second electrode 210 and dried to form the organic layer 230 having a reactive group F on the second electrode 210.

According to an embodiment of the inventive concept, a dye 310 may be disposed in the liquid crystal layer 300 through the reaction with the F group in the organic layer 230 and fixed instead of a color filter in the display device. The dye 310 may include an aromatic ring or a condensed ring. The aromatic ring or the condensed ring of the dye 310 may increase the interaction between liquid crystal molecules in the liquid crystal layer 300 having an aromatic molecular structure, thereby easily controlling the efficient alignment of dye molecules by an electric field.

According to an embodiment of the inventive concept, the dye 310 may include three colors of yellow, cyan and magenta including a reactive group. In addition, these colors may be mixed as occasion demands to realize red, blue and green.

Hereinafter, a yellow dye 310Y, a cyan dye 310C, and a magenta dye 310M will be explained in more detail.

The yellow dye 310Y according to an aspect of the inventive concept may have a structure including two aromatic rings connected via an azo group as illustrated in the following Formula 2.

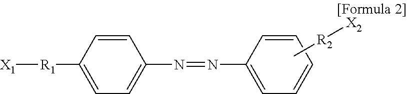

where R₁ and R₂ may be the same or different. R₁ and R₂ include at least one selected from the group consisting of —CH₂, C₂H₄, a linear alkyl group having at least C₃, a branched alkyl group having at least C₃, a linear alkene group having at least C₃, a branched alkene group having at least C₃, and at least one aromatic group. Alternatively, R₁ and R₂ include at least one selected from the group consisting of —N(CH₃), —N(C₂H₅), and —N(alkyl chain having at least C₃). X₁ and X₂ may be the same or different. X₁ and X₂ include at least one selected from the group consisting of —H, CH₂═CH, H₂N—, epoxy-, HO—, CH₃, C₂H₅, and an alkyl chain having at least C₃.

X₁ and X₂ of the yellow dye 310Y may react with the F group of the organic layer 230 and may be fixed to the organic layer 230. For example, X₁ and X₂ of the yellow dye 310Y may be fixed through a condensation reaction or an addition reaction with the F group of the organic layer 230.

The structure of the magenta dye 310M according to an aspect of the inventive concept is illustrated in the following Formula 3.

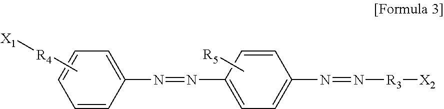

where R₄ and R₅ may be the same or different. R₄ and R₅ include at least one selected from the group consisting of —CH₂, —C₂H₄, a linear alkyl group having at least C₃, a branched alkyl group having at least C₃, a linear alkene group having at least C₃, a branched alkene group having at least C₃, and at least one aromatic group. Alternatively, R₄ and R₅ include at least one selected from the group consisting of —N(CH₃), —N(C₂H₅), and —N(alkyl chain having at least C₃). X₁ and X₂ may be the same or different. X₁ and X₂ include at least one selected from the group consisting of —H, CH₂═CH, H₂N—, epoxy-, HO—, CH₃, C₂H₅, and an alkyl chain having at least C₃. R₃ includes one of the compounds illustrated in the following Formula 4.

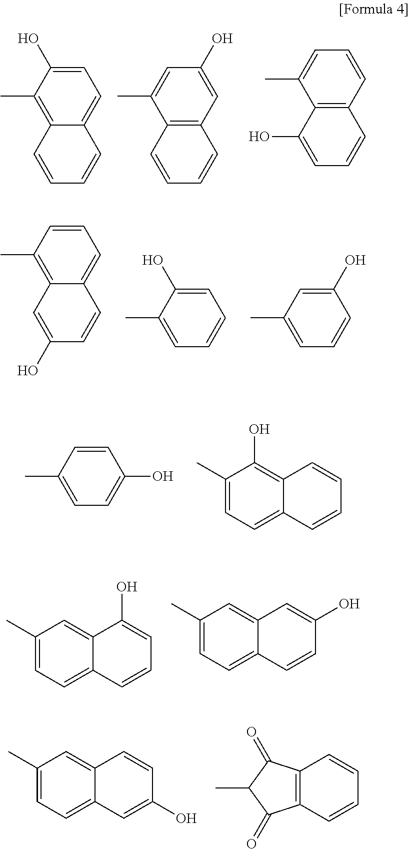

where X₁ and X₂ of the magenta dye 310M may react with the F group of the organic layer 230 and may be fixed to the organic layer 230. For example, X₁ and X₂ of the magenta dye 310M may be fixed through a condensation reaction or an addition reaction with the F group of the organic layer 230.

The structure of the cyan dye 310C according to an aspect of the inventive concept is illustrated in the following Formula 5.

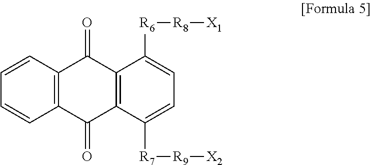

where R₆ and R₇ may be the same or different. R₆ includes at least one selected from the group consisting of O, S, Se, CH₂, NH and an ester group. R₇ includes at least one selected from the group consisting of O, S, Se, CH₂, NH and an ester group. R₈ and R₉ may be the same or different. R₈ includes at least one selected from the group consisting of —H, CH₂, C₂H₄, C₃H₆, C₄H₈, C₅H₁₀, a linear alkyl group having at least C₆, a branched alkyl group having at least C₆, a linear alkene group having at least C₃, a branched alkene group having at least C₃, and at least one aromatic group. R₉ includes at least one selected from the group consisting of —H, CH₃, C₂H₅, C₃H₈, C₄H₁₁, C₅H₁₄, a linear alkyl group having at least C₆, a branched alkyl group having at least C₆, a linear alkene group having at least C₃, a branched alkene group having at least C₃, and at least one aromatic group. X₁ and X₂ may be the same or different. X₁ and X₂ include at least one selected from the group consisting of H, CH₂═CH, H₂N—, epoxy-, HO—, CH₃, C₂H₅, and an alkyl chain having at least C₃.

X₁ and X₂ of the cyan dye 310C may react with the F group of the organic layer 230 and may be fixed to the organic layer 230. For example, X₁ and X₂ of the cyan dye 310C may be fixed through a condensation reaction or an addition reaction with the F group of the organic layer 230.

As described above, through the chemical reaction of the reactive groups X₁ and X₂ at the terminal of the dye 310 with the reactive functional group F of the organic layer 230, the dye 310 may be fixed to the organic layer 230.

According to another embodiment of the inventive concept, the dye 310 may further include a reactive monomer and an initiator, and the dye 310 may be fixed onto the surface of the organic layer 230 by using light, heat, or redox reaction. The reactive monomer may include at least one selected from the group consisting of an acrylate, epoxy, siloxane, acetate, pyrrolidone, ester, and amide group. The initiator may include at least one among a photo initiator, a thermal initiator and a redox initiator.

The photo initiator includes 1-hydroxy-cyclohexyl-phenyl-ketone (Irgacure 907), 2-methyl-1-[4-(methylthio)phenyl]-2-morpholinopropane-1-one (Irgacure 184C), 2-hydroxy-2-methyl-1-phenyl-propane-1-one (Darocur 1173), a mixture initiator (Irgacure 500) of 50 wt % of Irgacure 184C and 50 wt % of benzophenone, a mixture initiator (Irgacure 1000) of 20 wt % of Irgacure 184 and 80 wt % of Irgacure 1173, 2-hydroxy-1-[4-(2-hydroxyethoxy)phenyl]-2-methyl-1-propanone (Irgacure 2959), methylbenzoylformate (Darocur MBF), alpha, alpha-dimethoxy-alpha-phenylacetophenone (Irgacure 651), 2-benzyl-2-(dimethylamino)-1-[4-(morpholinyl)phenyl]-1-butanone (Irgacure 369), a mixture initiator (Irgacure 1300) of 30 wt % of Irgacure 369 and 70 wt % of Irgacure 651, diphenyl (2,4,6-trimethylbenzoyl)-phosphine oxide (Darocur TPO), a mixture initiator (Darocur 4265) of 50 wt % of Darocur TPO and 50 wt % of Darocur 1173, phosphine oxide, phenyl bis(2,4,6-trimethylbenzoyl) (Irgacure 819), a mixture initiator (Irgacure 2005) of 5 wt % of Irgacure 819 and 95 wt % of Darocur 95 wt %, a mixture initiator (Irgacure 2010) of 10 wt % of Irgacure 819 and 90 wt % of Darocur 1173, a mixture initiator (Irgacure 2020) of 20 wt % of Irgacure 819 and 80 wt % of Darocur 1173, bis(.eta.5-2,4-cyclopentadien-1-yl)bis[2,6-difluoro-3-(1H-pyrrol-1-yl)phenyl]titanium (Irgacure 784), a mixture initiator (HSP 188) including benzophenone, and these compounds may be used alone or a combination thereof may be used.

The thermal initiator includes benzoyl peroxide (BP), acetyl peroxide (AP), diauryl peroxide (DP), di-tert-butyl peroxide (t-BTP), cumyl hydroperoxide (CHP), hydrogen peroxide (HP), potassium peroxide (PP), 2,2′-azobisisobutyronitrile (AIBN), an azo compound initiator, and silver alkyls, and these compounds may be used alone or a combination thereof may be used.

The initiator using the redox reaction includes persulfate (K₂S₂O₈), and a redox initiator, and these compounds may be used alone or a combination thereof may be used.

According to an aspect of the inventive concept, the yellow dye 310Y, the cyan dye 310C, and the magenta dye 310M fixed onto the surface of the organic layer 230 may be formed as a single layer. As described above, red, green, and blue dyes may be obtained by mixing the yellow, cyan and magenta dyes 310Y, 310C and 310M. Differently, black may be realized by mixing the yellow dye 310Y, the cyan dye 310C, and the magenta dye 310M.

Even though not shown in detail, according to another embodiment of the inventive concept, color sub-pixels may be realized by using a lithography process.

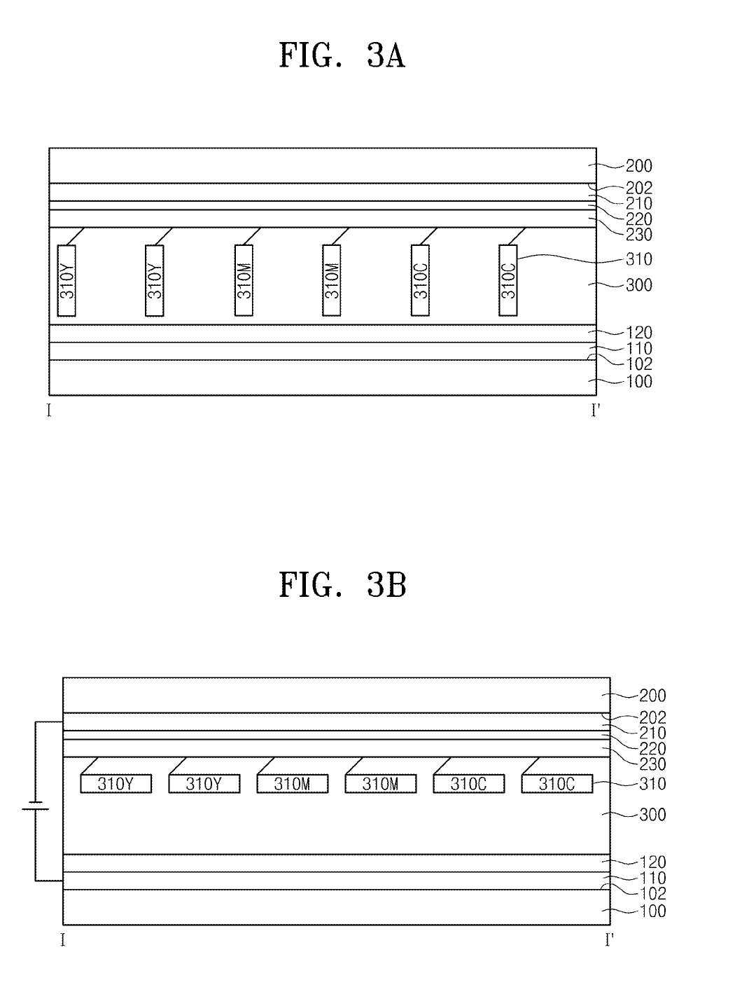

FIGS. 3A and 3B are cross-sectional views for explaining the driving method of the display device in FIG. 2.

Referring to FIG. 3A, the liquid crystal molecules of the liquid crystal layer 300 may be aligned in a vertical state with respect to the surface of the first or second substrate 100 or 200 when a voltage is not applied to the first electrode 110 and the second electrode 210 of the display device. Thus, the dye 310 fixed to the organic layer 230 in the liquid crystal layer 300 may be aligned in the vertical state with respect to the surface of the first or second substrate 100 or 200.

Referring to FIG. 3B, when a voltage is applied to the first electrode 110 and the second electrode 210 of the display device, the liquid crystal molecules in the liquid crystal layer may be aligned in a horizontal direction with respect to the surface of the first or second substrate 100 or 200. Thus, the dye 310 fixed to the organic layer 230 in the liquid crystal layer 300 may change the alignment thereof into the alignment direction of the liquid crystal molecules.

As described above, the alignment direction of the dye 310 fixed to the organic layer 230 in the display device may control the dichroism of the dye 310 by using the alignment direction of the liquid crystal depending on an electric field and may realize color images. Therefore, color images may be expressed by the driving of the liquid crystal molecules in the liquid crystal layer 300, and a driving voltage may be lowered. In addition, the dye 310 is fixed to the organic layer 230, and the change of the dye 310 according to driving characteristics is small, and thermal stability is good, when compared to a display device including a general guest-host liquid crystal layer 300 having a dispersed state of the dye 310 in the liquid crystal layer 300. Further, since a color filter and a polarization plate are not necessary, the display device may be manufactured economically with good manufacturing efficiency.

According to an embodiment of the inventive concept, when the display device is a twisted nematic (TN) mode, and an electric field is applied in the liquid crystal layer, the liquid crystal molecules may be aligned in the direction of an electric field, and the dye fixed to the organic layer also may be aligned in the direction of the liquid crystal. In this case, the color of the dye may be expressed when the electric field is not applied, and the device is transparent when the electric field is applied. Alternatively, the driving of a vertical alignment (VA) mode may be driven contrary to that of the TN mode.

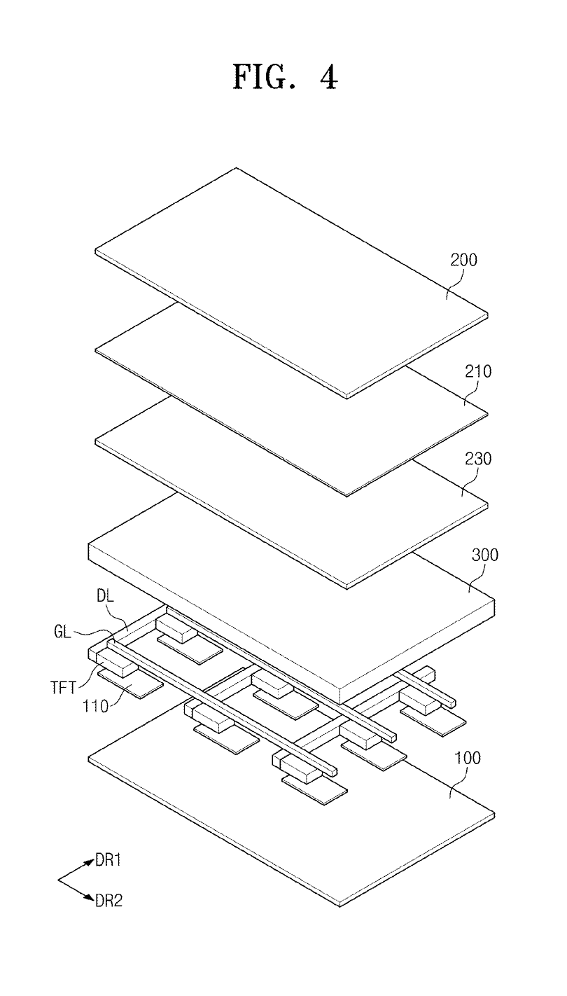

FIG. 4 is an exploded perspective view for explaining the display device according to another embodiment of the inventive concept.

Referring to FIG. 4, a display device may include a first substrate 100, a second substrate 200, and a liquid crystal layer 300 including a dye 310 and filling up the space between the first and second substrates 100 and 200. A display device having an active matrix structure will be explained as the display device according to this embodiment.

On one side of the first substrate 100, a thin film transistor TFT, a gate line GL, a data line DL, a first electrode 110 and a first insulation layer (not shown) are provided. The first electrode 110 may make an electrical connection with the thin film transistor TFT. Even though not shown in detail, six minute slits may be formed in the first electrode 110 to separate one pixel area into a plurality of domains.

On one side of the second substrate 200, a second electrode 210 and an organic layer 230 are provided. The second electrode 210 is a common electrode and may have a plate shape.

The explanation on other elements such as the first electrode 100, the second electrode 200, the dye 310, and the liquid crystal layer 300 is substantially the same as that of the elements explained in FIGS. 1 and 2. Thus, the explanation thereon will be omitted.

According to the embodiments of the inventive concept, color images may be realized by the dye 310 fixed to the organic layer 230 according to the alignment of liquid crystal molecules in the liquid crystal layer 300, and a color filter and a polarization plate are not necessary. Thus, the display device of the inventive concept may be economically manufactured, and manufacturing efficiency thereof may be good. In addition, since the dye 310 fixed to the organic layer 230 is used, the change of the dye 310 with respect to driving characteristics may be small, thermal stability of the display device may be good, and a driving voltage of the display device may be lowered.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A display device, comprising:
a first electrode;
a second electrode facing and separated from the first electrode;
a liquid crystal layer filling up a space between the first and second electrodes;
an organic layer disposed between the second electrode and the liquid crystal layer; and
a dye disposed in the liquid crystal layer and fixed to the organic layer.

2. The display device of claim 1, wherein the organic layer comprises at least one group selected from the group consisting of HS—, CH₂═CH—, epoxy- and Cl—, and the at least one group is a reactive group for fixing the dye.

3. The display device of claim 2, wherein the dye comprises at least one group selected from the group consisting of —H, CH₂═CH—, H₂N—, epoxy-, HO—, CH₃, C₂H₅, and an alkyl chain having at least C₃, and the at least one group reacts with a reactive group of the organic layer.

4. The display device of claim 1, wherein the dye comprises an aromatic ring or a condensed ring.

5. The display device of claim 1, wherein the organic layer comprises a compound having the following Formula: 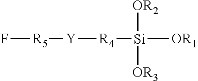
where R₁, R₂, and R₃ include H, CH₃, C₂H₅, and C₃H₇, R₄ includes CH₂, C₂H₄, C₃H₆, and C₄H₈, Y includes O, CONH, COO, and OCO, R₅ has an aliphatic compound structure of C₂ to C₇, F includes at least one selected from the group consisting of HS—, CH₂═CH—, epoxy-, and Cl—.

6. The display device of claim 1, wherein the dye comprises a yellow dye, a cyan dye, and a magenta dye.

7. The display device of claim 1, wherein the dye is aligned according to the alignment of liquid crystal molecules in the liquid crystal layer.

8. The display device of claim 7, wherein the liquid crystal molecules in the liquid crystal layer are aligned in a vertical direction with respect to a surface of the first electrode, and the dye fixed to the organic layer is aligned in a substantially the same direction as an alignment direction of the liquid crystal molecules to realize images, with voltage difference between the first and second electrodes.
